(19) United States
(12) Patent Application Publication
(10) Pub. No.: US 2019/0114073 A1
(43) Pub. Date: Apr. 18, 2019

(54) ELECTRONIC DEVICE AND METHOD OF PROVIDING SELECTABLE KEYS OF A KEYBOARD

(71) Applicant: BlackBerry Limited, Waterloo (CA)

(72) Inventor: Jeremy Lawson KOMINAR, Waterloo (CA)

(21) Appl. No.: 15/782,740

(22) Filed: Oct. 12, 2017

(51) Int. Cl. G06F 3/0488; G06F 3/0489; G06F 3/0486; G06F 9/44

(52) U.S. Cl. CPC G06F 3/04886; G06F 8/38; G06F 3/0486; G06F 3/04897

(57) ABSTRACT

An electronic device including a display and a method of providing selectable keys of a keyboard for input on the touch-sensitive display of the electronic device. The method includes displaying the keyboard including the keys in respective first locations on the touch-sensitive display of the electronic device, receiving, via the touch-sensitive display, an input associated with the keyboard, in response to identifying the input as an input to move keys of the keyboard, moving a plurality of the keys of the keyboard to respective second locations based on a direction of the input, receiving a selection of one of the keys of the keyboard, and in response to the selection of one of the keys, returning the keys of the keyboard to the respective first locations on the touch-sensitive display.

### FIELD OF TECHNOLOGY

The present disclosure relates to an electronic device and method of providing selectable keys of a keyboard.

### BACKGROUND

Electronic devices, have gained widespread use and may provide a variety of functions including, for example, telephonic, electronic messaging and other personal information manager (PIM) application functions. Electronic devices include several types of devices including mobile stations such as simple cellular telephones, smart telephones, wireless PDAs, and computers.

Such electronic devices are generally intended for handheld use and ease of portability. The sizes of such devices varies and while smaller devices are generally desirable for portability, somewhat larger devices are desirable for displaying information. Touch-sensitive displays are useful on such handheld devices as the space available for user input and output is limited. In addition, the screen content on the touch-sensitive devices can be modified depending on the functions and operations being performed. Demand for improvements in user input and output continues, however.

Improvements in electronic devices with touch-sensitive displays are desirable.

### BRIEF DESCRIPTION OF THE DRAWINGS

Embodiments of the present disclosure will now be described, by way of example only, with reference to the attached figures, in which:

FIG. 1 is a block diagram of a portable electronic device in accordance with the present disclosure;

FIG. 2 is a front view of an example of an electronic device in accordance with the present disclosure;

FIG. 3 is a flowchart illustrating a method of providing selectable keys of a keyboard in accordance with the present disclosure;

FIG. 4 through FIG. 6 illustrate an example of the method of providing selectable keys of a keyboard in accordance with the disclosure;

FIG. 7 through FIG. 10 illustrate examples of the method of providing selectable keys of a keyboard in accordance with the disclosure;

FIG. 11 through FIG. 13 illustrate another example of the method of providing selectable keys of a keyboard in accordance with the disclosure;

FIG. 14 through FIG. 16 illustrate yet another example of the method of providing selectable keys of a keyboard in accordance with the disclosure.

### DETAILED DESCRIPTION

The following describes an electronic device including a display and a method of providing selectable keys of a keyboard for input on the touch-sensitive display of the electronic device. The method includes displaying the keyboard including the keys in respective first locations on the touch-sensitive display of the electronic device, receiving, via the touch-sensitive display, an input associated with the keyboard, in response to identifying the input as an input to move keys of the keyboard, moving a plurality of the keys of the keyboard to respective second locations based on a direction of the input, receiving a selection of one of the keys of the keyboard, and in response to the selection of one of the keys, returning the keys of the keyboard to the respective first locations on the touch-sensitive display.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to an electronic device. Examples of electronic devices include mobile, or handheld, wireless communication devices such as cellular phones, cellular smart-phones, wireless organizers, personal digital assistants, computers, tablet computers, mobile internet devices, electronic navigation devices, and so forth.

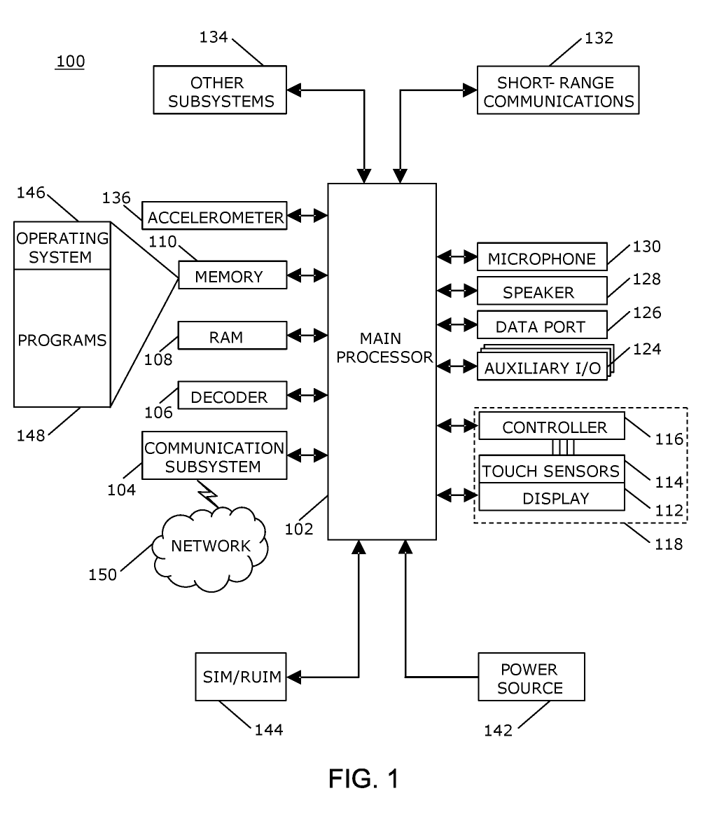

A block diagram of one example of an electronic device 100, which in the present example is a portable electronic device, is shown in FIG. 1. The electronic device 100 includes multiple components, such as a processor 102 that controls the overall operation of the electronic device 100. Communication functions, including data and voice communications, are performed through a communication subsystem 104. Data received by the electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the electronic device 100.

The processor 102 interacts with other components, such as a Random Access Memory (RAM) 108, memory 110, a touch-sensitive display 118, an auxiliary input/output (I/O) subsystem 124, a data port 126, a speaker 128, a microphone 130, short-range communications 132 and other device subsystems 134. The speaker 128, also referred to as an earpiece speaker, is utilized to output audible signals when a user's ear is very close to the speaker 128. Although not shown, the processor may also interact with a loudspeaker, for example, for hands-free use.

The touch-sensitive display 118 includes a display 112 and touch sensors 114 that are coupled to at least one controller 116 that is utilized to interact with the processor 102. Input via a graphical user interface is provided via the touch-sensitive display 118. Information, such as text, characters, symbols, images, icons, and other items that may be displayed or rendered on a portable electronic device, is displayed on the touch-sensitive display 118 via the processor 102. The processor 102 may also interact with an accelerometer 136 that may be utilized to detect direction of gravitational forces or gravity-induced reaction forces.

To identify a subscriber for network access, the electronic device 100 may utilize a Subscriber Identity Module or a Removable User Identity Module (SIM/RUIM) card 144 for communication with a network, such as the wireless network 150. Alternatively, user identification information may be programmed into memory 110.

The electronic device 100 includes an operating system 146 and software programs, applications, or components 148 that are executed by the processor 102 and are typically stored in a persistent, updatable store such as the memory 110. Additional applications or programs may be loaded onto the electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive touch-sensitive display that includes a plurality of capacitive touch sensors 114. Capacitive touch sensors 114 include drive electrodes, also known as transmission electrodes, and sense electrodes, also known as receive electrodes. The drive electrodes generally extend in one direction and cross over or under the sense electrodes, which generally extend in another direction, generally at right angles to the direction that the drive electrodes extend, to form a grid pattern. The drive electrodes are spaced from the sense electrodes by a dielectric material. The points at which the drive electrodes and the sense electrodes cross each other are referred to as nodes. The drive and sense electrodes may comprise any suitable material, such as indium tin oxide (ITO).

One or more touches, also known as touch contacts or touch events, may be detected by the touch-sensitive display 118. The processor 102 may determine attributes of the touch, including a location of the touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 118. A touch may be detected from any suitable input member, such as a finger, thumb, appendage, or other objects, for example, a stylus, pen, or other pointer, depending on the nature of the touch-sensitive display 118. Multiple simultaneous touches may be detected.

By repeatedly scanning the electrodes of the touch-sensitive display 118 to detect touches, movement of a touch relative to the touch-sensitive display 118 may be detected. One or more gestures may also be detected by the touch-sensitive display 118. A gesture, such as a swipe, also known as a flick, is a particular type of touch on a touch-sensitive display 118 and may begin at an origin point and continue to an end point, for example, a concluding end of the gesture. A gesture may be identified by attributes of the gesture, including the origin point, the end point, the distance traveled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

The touch-sensitive display 118 includes a display area in which information may be displayed, and a non-display area extending around the periphery of the display area. Information is not displayed in the non-display area of the display. The non-display area is utilized to accommodate, for example, electronic traces or electrical connections, adhesives or other sealants, and/or protective coatings around the edges of the display area. The non-display area may be referred to as an inactive area and is not part of the physical housing or frame of the electronic device. Typically, no pixels of the display are in the non-display area, thus no image can be displayed by the display 112 in the non-display area. Optionally, a secondary display, not part of the primary display 112, may be disposed in the non-display area. Touch sensors including drive electrodes and sense electrodes may be disposed in the non-display area, which touch sensors may be extended from the touch sensors in the display area or may be distinct or separate touch sensors from the touch sensors in the display area. A touch, including a gesture, may be associated with, i.e., performed on, the display area, the non-display area, or both areas. The touch sensors including the drive electrodes and the sense electrodes may extend across substantially the entire non-display area or may be disposed in only part of the non-display area.

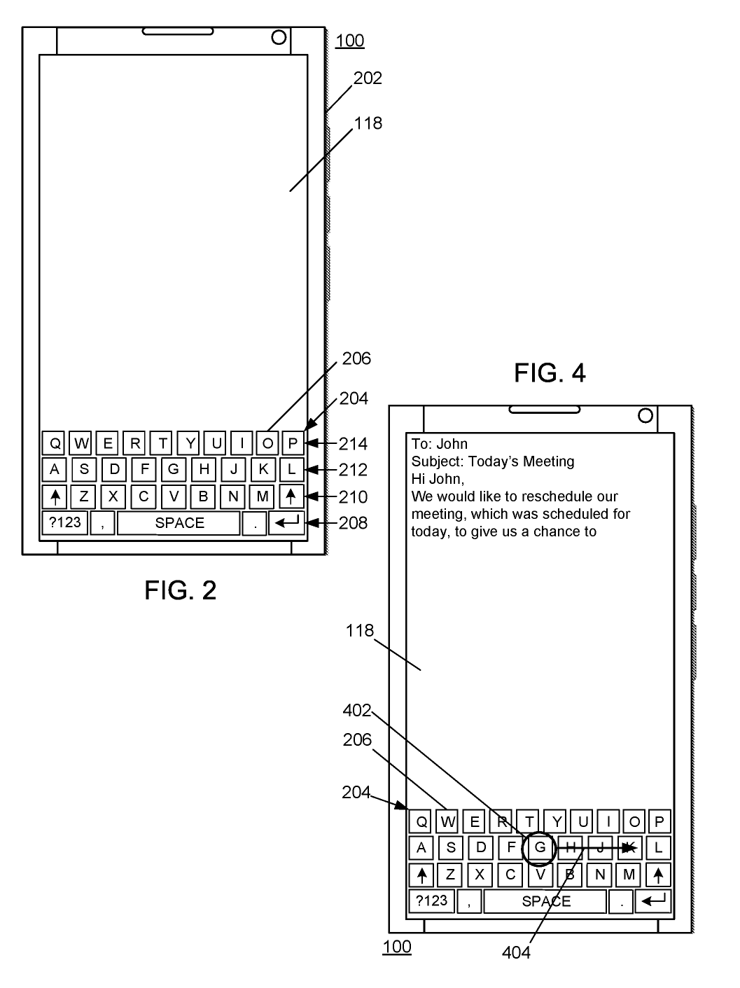

An example of an electronic device including selectable keys of a keyboard is shown in FIG. 2. In the present example, the electronic device 100 includes a housing 202 in which the touch-sensitive display 118 is disposed. The housing 202 is utilized to enclose components such as the components shown in FIG. 1.

In the example illustrated in FIG. 2, a virtual keyboard 204 is shown. The virtual keyboard 204 includes a plurality of keys 206. Each of the keys 206 of the keyboard 204 is associated with a character such that a character is entered in response to a touch on a location on the touch-sensitive display 118 associated with the respective key 206. The keyboard 204 in the present example, includes four rows of keys 206, including a first, or bottom, row 208, which includes a space key, a second row 210, a third row 212, and a fourth, or top, row 214. Other numbers of rows of keys may be implemented, however.

For the purpose of the present example, the keyboard 204 illustrated in FIG. 2 is a QWERTY keyboard. Other keyboards, such as AZERTY, QWERTZ or any other keyboard, including characters of any language, may be implemented.

In addition to the keyboard 204, information may be displayed on the touch-sensitive display 118. The information displayed may include any suitable information such as icons, text, pictures, video, documents, a webpage, or any other suitable information. The information may be associated with, for example, a home page, a menu or submenu, an application or applications, a webpage, and so forth.

The information may be any suitable information associated with an application on the electronic device 100, including information received via an internet connection. The information may also be information or content created or composed on the electronic device 100, such as a document, message, or other information stored in memory 110, or composed utilizing the keyboard 204.

The electronic device 100 illustrated in FIG. 2 may be intended for handheld use. The electronic device 100, however, is of sufficient size to provide the keyboard 204 in which each key is associated with a respective character, and a display area to display the information on the touch-sensitive display 118, above the keyboard 204 in the orientation illustrated in FIG. 2.

When the electronic device 100 is held in a single hand, selecting keys 206 on both the left and right sides of the keyboard 204 may be difficult. For example, a user holding the electronic device 100 in the right hand may select keys 206 on or near a right side of the keyboard 204. The user may not be able to select keys 206 on a left side of the keyboard 204, such as the keys 206 on the far left side, however, as the user may not be able to reach across to touch the touch-sensitive display 118 on the far left side. Thus, without utilizing both right and left hands, selectable features on the touch-sensitive display 118 may be difficult to select.

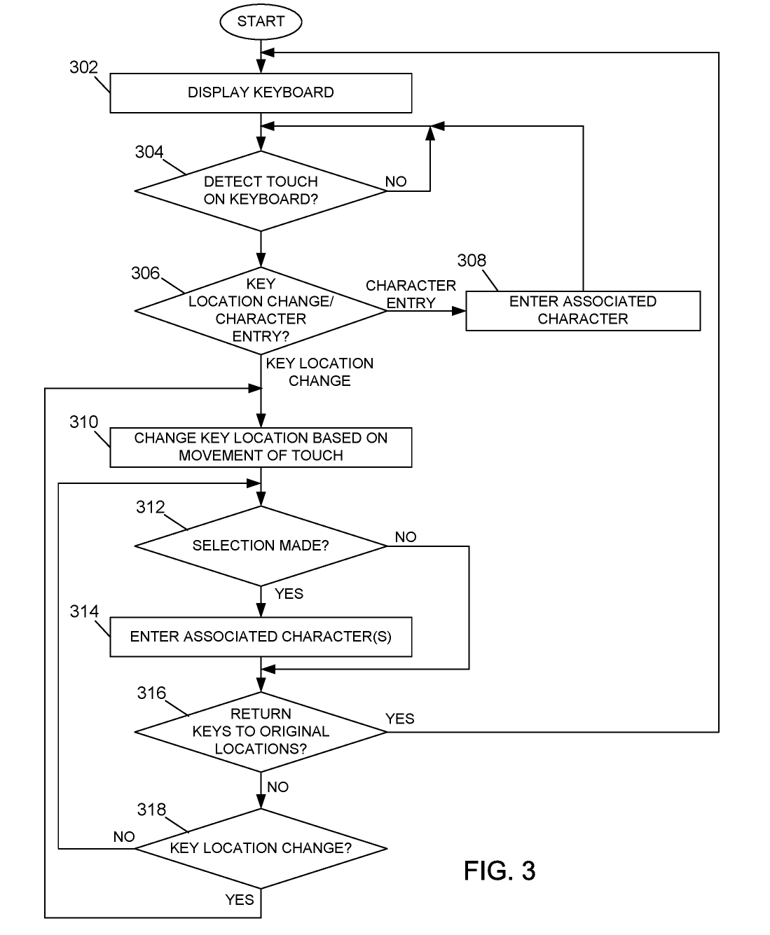

A flowchart illustrating a method of providing selectable keys of a keyboard for input on the touch-sensitive display of the electronic device is shown in FIG. 3. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor, such as the processor 102 of the portable electronic device 100, to perform the method may be stored in a computer-readable storage medium, such as a non-transitory computer-readable medium.

The virtual keyboard 204, including the keys 206, is displayed on the touch-sensitive display 118 at 302. The keyboard 204 may be displayed in association with an application executed by the processor 102, such as, for example, an electronic mail, calendar, address book, word processor, Web browser, or any other suitable application. The keyboard 204 may be displayed for entry of information, such as during composition of a document, message, note, calendar event, or any other suitable information. For example, the keyboard 204 may be displayed in response to launching an application, such as opening a word processing document, in response to selection of a field of a message, a field of a calendar event, a field of a Webpage, or in response to any other suitable action or event for entry of information.

In response to detecting a touch on the keyboard at 304, the process continues at 306. A determination is made at 306 whether the touch is associated with a change in location of the keys 206 of the keyboard 204 or selection of a key 206 of the keyboard 204 for character entry. A gesture such as a drag gesture or sliding gesture that begins at an origin location and moves generally in a straight line, may be associated with a change in key location, for example. A touch on a location associated with a key 204 and that is generally unchanged, i.e., the touch begins and ends on the same key 206 of the keyboard 204, may be associated with selection of the key 206 for entry of the associated character.

In response to determining that the touch is associated with selection of a key 206 of the keyboard 204, the associated character is entered at 308 and the process continues at 304. The associated character may be entered into a document or field displayed on the touch-sensitive display 118, for example, above the keyboard 204.

In response to determining that the touch is a gesture associated with a change in the location of keys 206 of the keyboard 204, the process continues at 310 and the locations of keys 206 of the keyboard 204 are changed based on the movement of the touch.

In one example, the keys of the keyboard may be moved in the direction of the gesture such that the locations of keys 206 in each row are changed. The keyboard 204 may be moved such that some of the keys 206 are no longer visible on the display. Thus, keys 206 appear to be moved off of the displayable area of the display. For example, keys on the right side of the display, such as the keys associated with the P, L, shift, and Enter, may be moved off the display as a drag gesture from left to right moves the keys 206 keyboard 204 from the locations shown in FIG. 2, toward the right. As the drag gesture continues, further keys may appear to be moved off of the touch-sensitive display 118.

According to another example, keys 206 in a single row may be moved in the direction of the gesture such that the locations of only the keys 206 in that row are changed. As the gesture progresses, keys within that single row may appear to be moved off the touch-sensitive display.

The keys 206 that are still visible are selectable by a touch on the touch-sensitive display 118, on an area associated with, i.e., on, the displayed keys 206 in the new locations of the keys.

Optionally, as the keys are moved with the gesture at 310, a space is created on one side of the display. For example, as keys of a row of the keyboard 204 or keys 206 of the entire keyboard 204 are moved to the right, a space in which no keys 206 are displayed is created on the left side. Similarly, as keys of a row of the keyboard 204 or keys 206 of the entire keyboard 204 are moved to the left, a space in which no keys 206 are displayed is created on the right side.

Alternatively, new keys or selectable elements may be exposed rather than a blank space being created. For example, a numerical keypad may be exposed. Alternatively or in addition, to numerical keys, punctuation keys, symbol keys, emoticons, selectable words, selectable phrases, or any other selectable elements may be exposed such that these additional keys are selectable by a touch on the area of the touch-sensitive display 118 at which the exposed keys are displayed.

In response to selection of a key at 312, the process continues at 314. A key may be selected at 312 in any suitable manner. For example, a key of the keyboard 204 may be selected in response to detecting a touch at the location on the touch-sensitive display 118 associated with that key after the gesture associated with a change in the location of keys 206 of the keyboard 204 ends. Alternatively, a key of the keyboard 204 may be selected based on the location of the keys 206 when the gesture to move a row of keys 206 is discontinued or ends. For example, a key that is at a predetermined location, identified, for example, by a cursor, highlighting, or any other suitable identifier, may be automatically selected when the gesture ends.

The character or function associated with the selected key is entered at 314. A character is therefore added to the displayed information on the touch-sensitive display 118 or the function is performed. For example, in response to selection of a key associated with a character, the character is added to the document, or to the field of the message, note, calendar event, Webpage, or any other suitable field. In response to selection of a function key, such as an enter or shift key, the function is performed.

A determination is made whether or not to return the keys 206 to their original locations at 316. In response to determining that the keys are to return to their original locations, the keys 206 are returned to the locations originally shown, for example, to the locations as illustrated in FIG. 2, and the process continues at 302. The keys 206 may be returned to their original locations, for example, in response to selection of a character at 312, or in response to entry of a function key at 312. In the example of selection of a key located at a predetermined location when the gesture to move the keys 206 ends, the keys 206 may be returned to their original locations in response to detecting the end of the gesture to move the keys 206. The keys 206 may also be returned to their original locations, for example, in response to detection of a touch on an area of the touch-sensitive display 118 at which no keys or selectable elements are displayed. Optionally, the keys 206 may be returned to their original locations after a timeout period of time without receipt of an input at the electronic device 100.

The key locations may also be further changed. For example, in response to detecting a gesture such as a drag gesture beginning on the keyboard 204, the process continues at 310 and the entire keyboard 204 of a row of the keys 206 are moved based on the movement of the gesture.

Reference is made again to FIG. 2 with reference to FIG. 4 through FIG. 6 to describe a particular example of the method of providing selectable keys of a keyboard for input on the touch-sensitive display of the electronic device, in accordance with the disclosure.

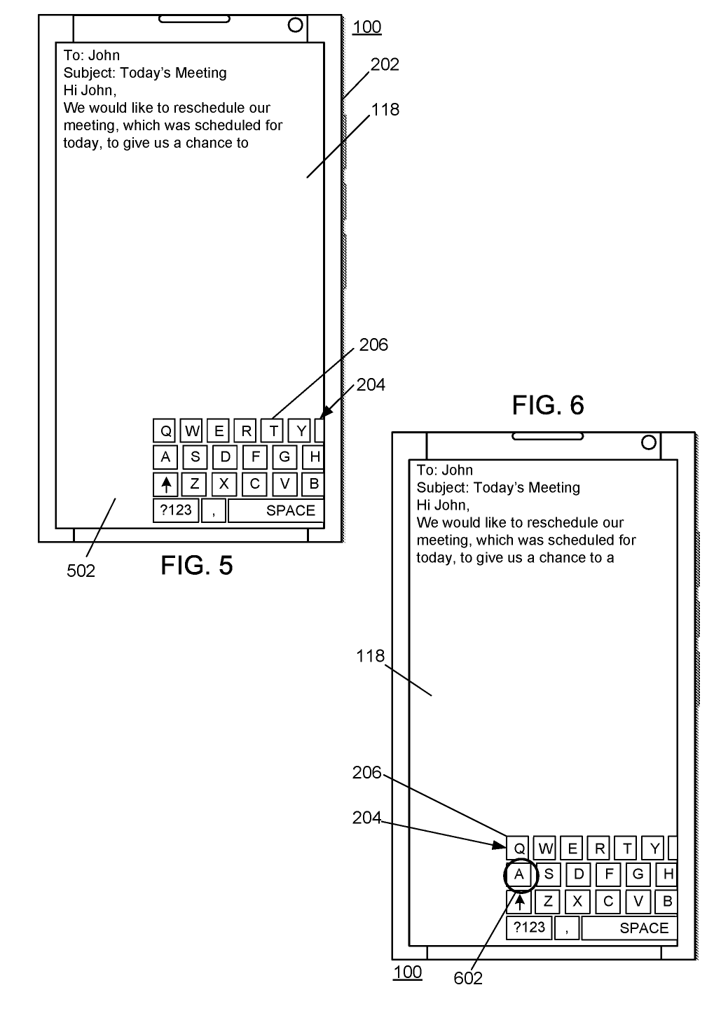

In the example of FIG. 2, FIG. 4, and FIG. 5, the keyboard 204 is displayed in an email composition interface. Thus, the electronic device 100 enters the email composition interface for the composition of an email.

For the purpose of the present example, a touch is detected on the keyboard at 304, as illustrated by the circle 402 in FIG. 4. The touch is a drag gesture in which touch contact with the touch-sensitive display 118 is maintained as the touch moves from a location on the key associated with the character “G”, to the right, as illustrated by the arrow 404.

A determination is made at 306 that the touch and drag gesture is associated with a change in location of the keys 206 of the keyboard 204 and the locations of the keys 206 of the keyboard 204 are changed based on the movement of the touch. The keys 206 of the keyboard 204 are therefore moved from left to right, in the same direction of the touch and drag gesture, such that the locations of keys 206 in each row are changed. The keyboard 204 is moved about the same distance as the touch such that several of the keys 206 are no longer visible on the display, as illustrated in FIG. 5. Thus, the keys 206 on the right side of the keyboard appear to be moved off of the displayable area of the touch-sensitive display 118. In the present example, a space 502 is created on the left side of the display as the keys are moved with the gesture at 310.

The remaining keys 206 that are displayed are selectable by a touch on the touch-sensitive display 118, on the new area associated with the displayed keys 206.

A touch is detected and the key associated with the letter “A” is selected at 312, as illustrated by the circle 602. The letter “A” is entered into the field of the message at 314. For the purpose of the present example, the keys 206 of the keyboard 204 are returned to the original position in response the selection of the key associated with the letter “A”, as illustrated in FIG. 6.

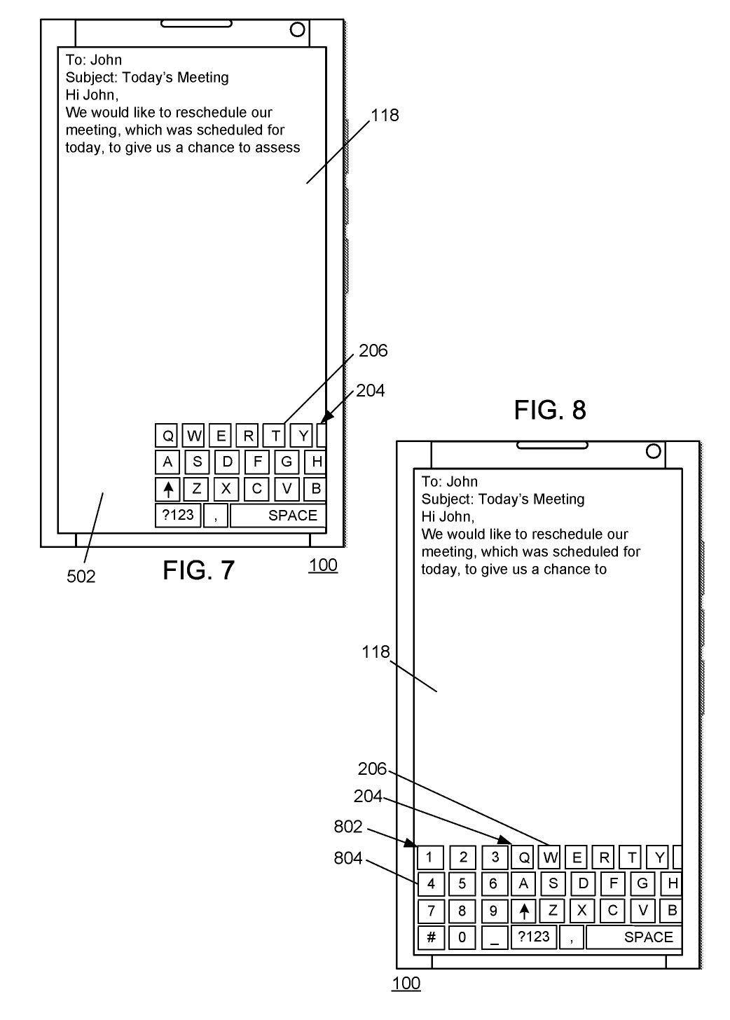

Referring now to FIG. 7, another example is illustrated. In this example, a user-selectable option to maintain the keys 206 in the locations to which the keys 206 are moved, is selected. For example, such an option may be provided in a settings menu or submenu. Thus, rather than the keys returning to the original position in response to selection of a key, the keys are returned in response to a touch on the touch-sensitive display 118, on the space created on the left side of the keyboard 204. Thus, the keys 206 of the keyboard 204 may be maintained in the locations shown in FIG. 5 until the a touch is detected on the space 502. Thus, for example, for the term “assess”, the keys 206 of the keyboard 204 may remain moved to the right side as the entire word is typed, reducing the number of dragging operations for typing when successive characters are located on a same side of the keyboard 204.

In the examples described above with reference to FIG. 4 through FIG. 7, the keys 206 of the keyboard 204 are moved generally in the same direction as the gesture and a space is created on the left side of the display as the keys 206 are moved with the gesture at 310. Reference is now made to FIG. 8 to describe yet another example. Rather than creating a space as the keys 206 are moved with the gesture, a numerical keypad 802 is exposed. Display of the numerical keypad may be animated such that the numerical keypad 802 appears to be dragged over from one side, along with the keyboard 204. Alternatively, display of the numerical keypad may be animated such that the numerical keypad 802 appears to be exposed by moving the keyboard 204 out of the area in which the numerical keypad 802 is displayed. With the keys 206 of the keyboard 204 moved to their second locations as illustrated in FIG. 8, the numerical keys 804 of the numerical keypad 802 are selectable by, for example, a touch detected on the area of the touchscreen display 118 associated with a numerical key 804 of the numerical keypad 802.

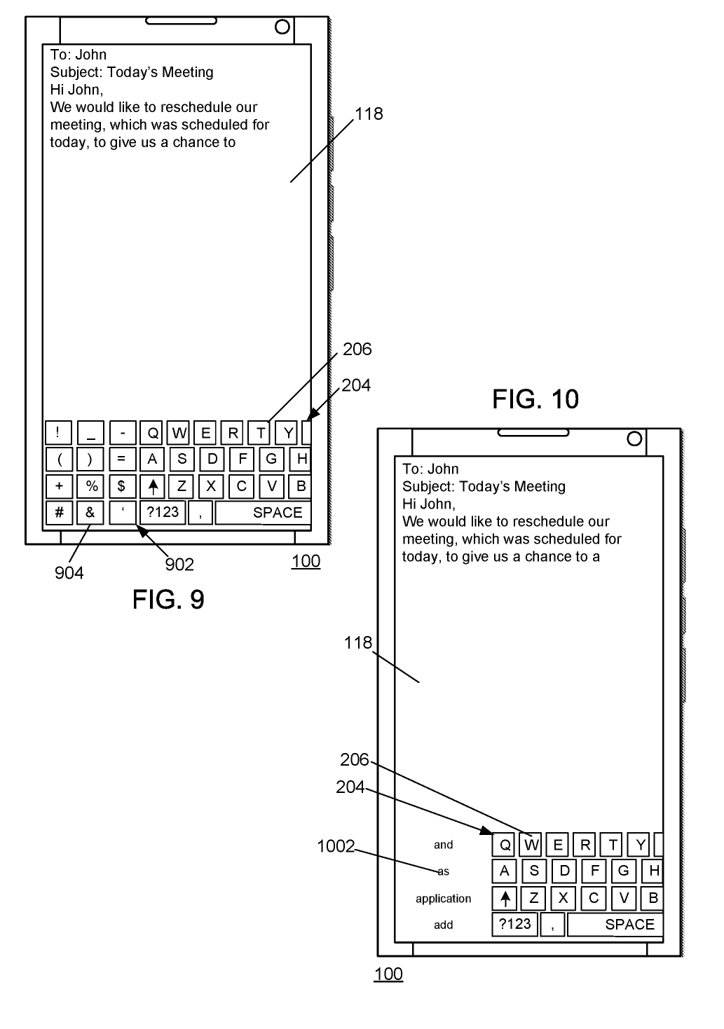

Referring now made to FIG. 9 to describe yet another example, the keys 206 are moved with the gesture. As with the example illustrated in FIG. 8, rather than creating a space as the keys 206 are moved with the gesture, further keys are exposed. In this example, symbol keys 904 of a symbol keypad 902 are exposed. As with the example described with reference to FIG. 8, display of the symbol keypad 902 may be animated such that the symbol keypad 902 appears to be dragged over from one side, along with the keyboard 204, or the symbol keypad 902 appears to be exposed by moving the keyboard 204 out of the area in which the symbol keypad 902 is displayed. With the keys 206 of the keyboard 204 moved to their second locations as illustrated in FIG. 9, the symbol keys 904 of the symbol keypad 902 are selectable by, for example, a touch detected on the area of the touchscreen display 118 associated with a symbol key 904 of the symbol keypad 902.

Referring now made to FIG. 10 to describe yet another example, the keys 206 are moved with the gesture as described above. As with the example illustrated in FIG. 8, rather than creating a space as the keys 206 are moved with the gesture, further selectable elements are exposed. In this example, selectable words 1002 are exposed. As with the example described with reference to FIG. 8, display of the selectable words 1002 may be animated such that the selectable words 1002 appear to be dragged over from one side, along with the keyboard 204, or the selectable words 1002 may appear to be exposed by moving the keyboard 204 out of the area in which the selectable words 1002 are displayed. With the keys 206 of the keyboard 204 moved to their second locations as illustrated in FIG. 10, the selectable words 1002 are selectable by, for example, a touch detected on an area of the touchscreen display 118 associated with one of the selectable words 1002. The selectable words 1002 may be determined on any suitable basis. For example, the selectable words 1002 may be displayed based on disambiguation, frequency of use of words, frequency of use of phrases, and any other suitable criteria. The selectable words may be contextual based on the application executed by the processor of the electronic device and in association with which the keyboard is displayed. Thus, the selectable words 1002 may be displayed based on disambiguation, frequency of use of words or phrases, in the context of the application running on the electronic device.

Alternatively, or in addition to exposing further selectable keys or elements, function keys or other keys that are moved off the touch-sensitive display 118 may also added to an opposite side of the touch-sensitive display 118. In the example illustrated in FIG. 5, the Enter key is moved off the touch-sensitive display by a touch and drag gesture. Optionally, an Enter key may be added in the space on the left side of the keyboard 204 as the Enter key on the right side is moved off the touch-sensitive display 118. Other keys, such as a backspace key, or any other suitable key may also be added. The additional keys may be displayed in a column including, for example, an enter key and a backspace key.

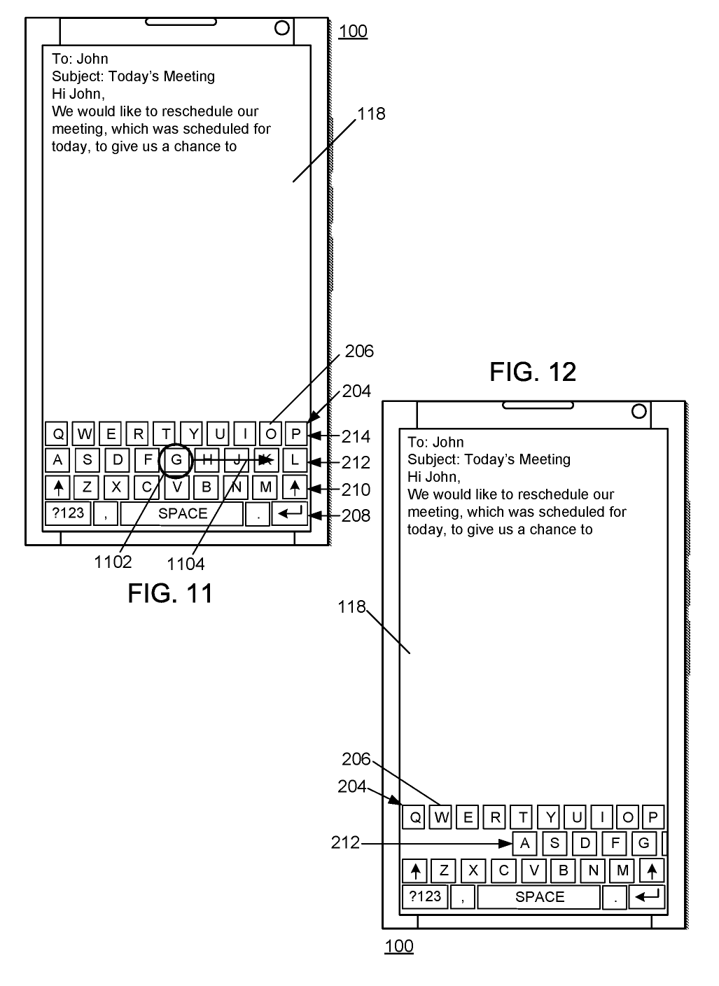

Reference now made to FIG. 3 and to FIG. 11 through FIG. 13 to describe another example of the method of providing selectable keys of a keyboard for input on the touch-sensitive display of the electronic device, in accordance with the disclosure.

For the purpose of the present example, the keyboard 204 is displayed in an email composition interface and a touch is detected on the keyboard 204 at 304, as illustrated by the circle 1102 in FIG. 11. The touch is a drag gesture in which touch contact with the touch-sensitive display 118 is maintained as the touch moves from an origin on the key associated with the character “G”, to the right, as depicted by the arrow 1104.

A determination is made at 306 that the touch and drag gesture is associated with a change in location of keys 206 of the keyboard 204 and the locations of the keys 206 of the third row 212 are changed based on the movement of the touch, as illustrated in FIG. 12. The keys 206 of the third row 212 are therefore moved from left to right, in the same direction as the touch and drag gesture, such that the locations of keys 206 in the third row 212 are changed. The third row 212 of keys 206 is moved about the same distance as the touch such that some of the keys 206 of the third row 212 are no longer visible on the touch-sensitive display 118, as illustrated in FIG. 5. Thus, the keys 206 on the right side of the third row 212 of the keyboard 204 appear to be moved off of the displayable area of the touch-sensitive display 118. In the present example, a space is created on the left side of the touch-sensitive display 118 as the keys 206 of the third row 212 are moved with the gesture at 310.

The remaining keys 206 that are displayed are selectable by a touch on the touch-sensitive display 118, on the new area associated with the displayed keys 206.

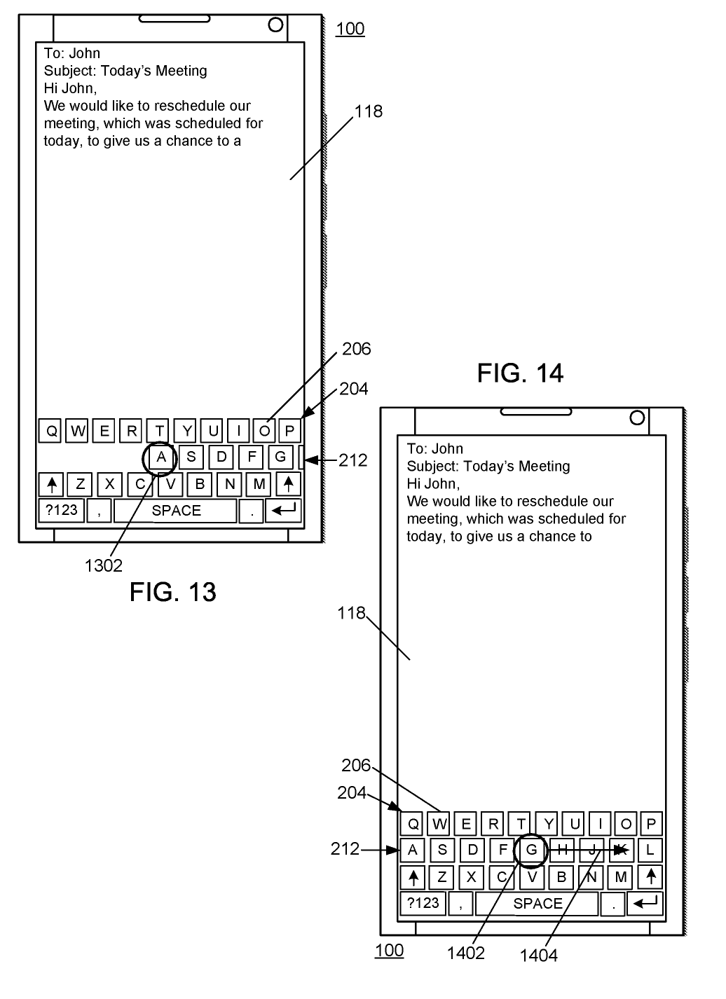

A touch is detected and the key associated with the letter “A” is selected at 312, as illustrated by the circle 1302 in FIG. 13. The letter “A” is entered into the field of the message at 314. For the purpose of the present example, the keys 206 of the third row 212 are returned to the original position in response the selection of the key associated with the letter “A”.

As described above with reference to FIG. 8 through 10, rather than creating a space beside the keys 206 that are moved to the right, further selectable keys may be exposed.

Referring now FIG. 3 and to FIG. 14 through FIG. 16, yet another example of the method of providing selectable keys of a keyboard for input on the touch-sensitive display of the electronic device, in accordance with the disclosure, is provided.

For the purpose of the present example, the keyboard 204 is displayed in an email composition interface and a touch is detected on the keyboard 204 at 304, as illustrated by the circle 1402 in FIG. 14. The touch is a drag gesture in which touch contact with the touch-sensitive display 118 is maintained as the touch moves from a location on the key associated with the character “G”, to the right, as illustrated by the arrow 1404.

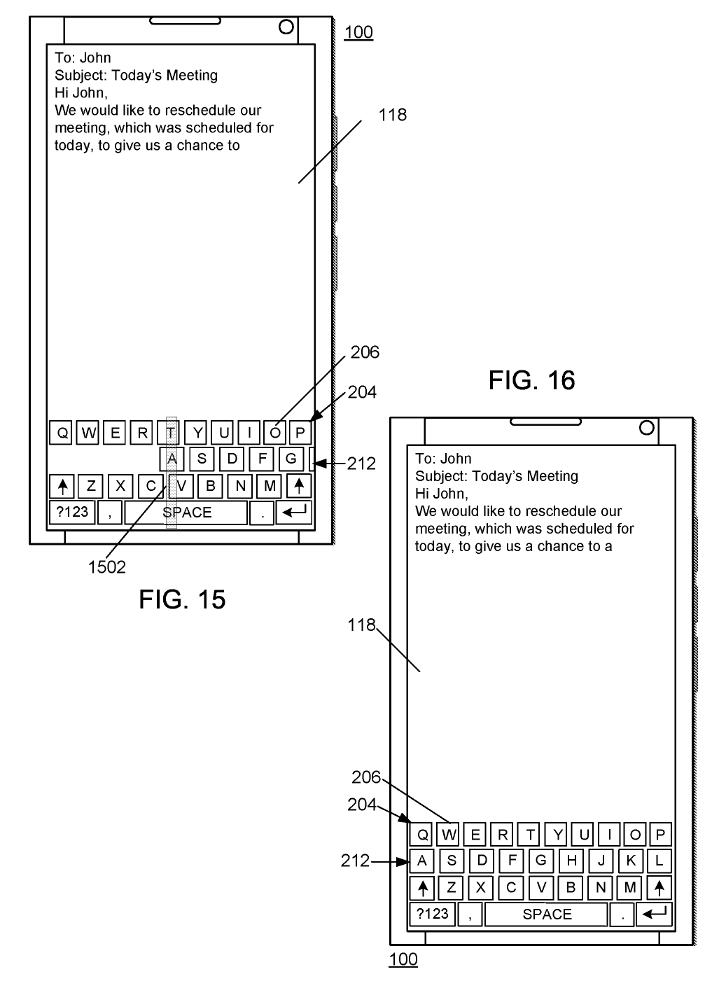

A determination is made at 306 that the touch and drag gesture is associated with a change in location of keys 206 of the keyboard 204 and the locations of the keys 206 of the third row 212 are changed based on the movement of the touch, as illustrated in FIG. 15. The keys 206 of the third row 212 are therefore moved from left to right, in the same direction as the touch and drag gesture, such that the locations of keys 206 in the third row 212 are changed. In the present example, however, a highlighted area 1502 appears on the touch-sensitive display 118 as the drag gesture begins. Thus, the highlighted area 1502 is displayed in response to detecting the drag gesture.

The third row 212 of keys 206 is moved along with the movement of the touch such that some of the keys 206 of the third row 212 are no longer visible on the touch-sensitive display 118, as illustrated in FIG. 15. Any key 206 of the third row 212 is selectable by moving the key 206 such that the key 206 intersects the highlighted area 1502 on the touch-sensitive display 118. The highlighted area 1502 is therefore provided as a guide to identify an area at which a key 206 is selected. Movement of the third row 212 of keys 206 continues until the desired key 206 of the third row 212 is in the area, i.e., intersects the highlighted area 1502, resulting in selection of that key 206. For the purpose of the present example, the keys 206 of the third row 212 are returned to the original position as illustrated in FIG. 16, in response the selection of the key associated with the letter “A”. The area may be a predetermined area or location that is user-configured such that the user, utilizing, for example, a setting on the electronic device, identifies the area. Alternatively, the area may be a default area.

Although a highlighted area is provided in the example described with reference to FIG. 15, other identifiers may be utilized such as a cursor, a box, or any other identifier of the predetermined location. Further, any row of the keys 206 may be similarly moved to select a key.

In the examples described herein, the keys 206 of the keyboard 204 are moved from left to right in response to detection of a gesture from left to right. The keys 206 of the keyboard 204 are also moved from right to left in response to detection of a gesture from right to left.

Optionally, the movement of the row of keys 206 of the keyboard 204 or the movement of the entire keyboard 204 in response to the gesture may be user-selectable. For example, a menu or submenu may be provided such that the either a row of keys 206 is moved or the entire keyboard moves based on the user selected option. In addition, further keys such as the numerical keys, the symbol keys, or the selectable words or phrases may also be user-selectable such that the electronic device 100 is configured to provide each of the above-described methods of providing selectable keys and the method utilized is dependent on options that are selectable in a menu or submenu related to the keyboard.

Advantageously, the electronic device and method facilitate use of the electronic device and use of a virtual keyboard with one hand. The distance that the user reaches to select a key may be reduced facilitating use of all keys of the keyboard utilizing a single hand. Such a method may also reduce the number of errors introduced that result from reaching across to type characters on an opposing side of a keyboard, thus reducing the time for character entry and the resulting battery use during character entry.

The scope of the claims should not be limited by the preferred embodiments set forth in the examples, but should be given the broadest interpretation consistent with the description as a whole.

What is claimed is:

1. A method of providing selectable keys of a keyboard for input on a touch-sensitive display of an electronic device, the method comprising:
displaying the keyboard including the selectable keys in respective first locations on the touch-sensitive display of the electronic device;
receiving, via the touch-sensitive display, an input associated with the keyboard;
in response to identifying the input as an input to move keys of the keyboard, moving a plurality of the keys of the keyboard to respective second locations based on a direction of the input;
receiving a selection of one of the keys of the keyboard;
in response to the selection of one of the keys, returning the keys of the keyboard to the respective first locations on the touch-sensitive display.

2. The method according to claim 1, wherein moving the plurality of the keys of the keyboard comprises moving keys of a single row of the keyboard.

3. The method according to claim 2, wherein the input comprises a touch and drag event and the single row is selected based on an origin of the touch and drag event.

4. The method according to claim 3, wherein receiving the selection of the one of the keys comprises detecting an end of the touch and drag event.

5. The method according to claim 4, comprising entering a character associated with a key disposed at predetermined location on the touch-sensitive display, at the end of the touch and drag event.

6. The method according to claim 1, wherein moving the plurality of the keys of the keyboard comprises moving all of the keys of the keyboard together.

7. The method according to claim 6, wherein receiving the selection of one of the keys comprises receiving selection of an enter key such that the keys of the keyboard are returned to the respective first locations in response to receipt of selection of the enter key.

8. The method according to claim 7, comprising maintaining all of the keys of the keyboard at the respective second locations in response to receipt of selection of an option to maintain the keys of the keyboard.

9. The method according to claim 8, wherein receiving the selection of the one of the keys of the keyboard comprises receiving selection of any one of the keys of the keyboard such that the keys of the keyboard are returned to the respective first locations in response to receipt of selection of any key of the keyboard.

10. The method according to claim 1, wherein moving the plurality of the keys of the keyboard to respective second locations comprises moving the plurality of the keys to create a space on one side of the keyboard.

11. The method according to claim 10, comprising displaying additional keys in the space on the one side.

12. The method according to claim 11, wherein the additional keys comprise one or more of numerical keys, punctuation keys, an enter key, and a backspace key.

13. The method according to claim 10, comprising displaying selectable widgets in the space on the one side.

14. The method according to claim 10, comprising displaying selectable words or phrases in the space on the one side, the selectable words or phrases displayed based on an application in association with which the keyboard is displayed such that the words or phrases displayed are application dependent.

15. The method according to claim 10, comprising returning the keys of the keyboard to the respective first locations on the touch-sensitive display in response to detecting a touch in the space on the one side.

16. A non-transitory computer-readable medium having computer-readable code stored thereon, the computer-readable code executable by at least one processor of an electronic device to:
display a keyboard including keys in respective first locations on a touch-sensitive display of the electronic device;
receive, via the touch-sensitive display, an input associated with the keyboard;
in response to identifying the input as an input to move keys of the keyboard, move a plurality of the keys of the keyboard to respective second locations based on a direction of the input;
receive a selection of one of the keys of the keyboard;
in response to receipt of the selection of one of the keys, return the keys of the keyboard to the respective first locations on the touch-sensitive display.

17. An electronic device comprising:
a touch-sensitive display for displaying information and receiving input;
a processor operably coupled to the touch-sensitive display to control the touch-sensitive display and:
display a keyboard including keys in respective first locations on the touch-sensitive display;
receive, via the touch-sensitive display, an input associated with the first keyboard;
in response to identifying the input as an input to move keys of the keyboard, move a plurality of the keys of the keyboard to respective second locations based on a direction of the input;
receive a selection of one of the keys of the keyboard;
in response to receipt of the selection of one of the keys, return the keys of the keyboard to the respective first locations on the touch-sensitive display.

18. The electronic device according to claim 11, wherein the plurality of the keys of the keyboard comprise keys of a single row of the keyboard selected based on an origin location of the input associated with the keyboard.

19. The electronic device according to claim 11, wherein the one of the keys is selected based on a location of the one of the keys at the end of the input associated with the keyboard.

20. The electronic device according to claim 11, wherein all of the keys of the keyboard are moved in response to identifying the input to move keys.
